(19) United States
(12) Patent Application Publication
(10) Pub. No.: US 2025/0163959 A1
(43) Pub. Date: May 22, 2025

(54) Rolling Bearing Device

(71) Applicant: Bayerische Motoren Werke Aktiengesellschaft, Muenchen (DE)

(72) Inventors: Oguzhan KIVAN, Muenchen (DE); Michael STAAKE, Muenchen (DE)

(21) Appl. No.: 18/841,448

(22) PCT Filed: Mar. 13, 2023
(86) PCT No.: PCT/EP2023/056271

§ 371 Date: Aug. 26, 2024

(30) Foreign Application Priority Data
Apr. 5, 2022 (DE) 10 2022 108 059.5

(51) Int. Cl. F16C 19/16; F16C 33/58

(52) U.S. Cl. CPC F16C 19/16; F16C 33/583

(57) ABSTRACT

A rolling bearing device comprises a radial bearing with a first multiplicity of rolling bodies and an axial bearing with a second multiplicity of rolling bodies, wherein the rolling bearing device is configured for the rotatable mounting of a shaft component about a bearing axis in relation to a housing component.

### BACKGROUND AND SUMMARY

This disclosure relates to a rolling bearing device. The prior art discloses rolling bearing devices having a plurality of rolling bearings, with EP 2 508 767 A1 disclosing a combined radial thrust bearing.

This disclosure will be described below in conjunction with a drive arrangement for a motor vehicle, although the disclosure is not to be understood as being limited to this application. There is a need in motor vehicles for functions to be implemented in a small installation space; this also applies to the drive of a motor vehicle. In the drive of a motor vehicle, drive and transmission shafts are to be mounted rotatably with respect to a housing. The mounting is generally intended to absorb axial and radial forces, and this functionality can be split between two bearing points. However, the prior art, in particular EP 2 508 767 A1, also discloses a combined radial thrust bearing, with such a combined radial thrust bearing being able to be used to absorb both axial and radial forces, the radial forces being absorbed by a roller bearing and the axial forces being absorbed by a ball bearing. In order to achieve a small installation space requirement, it is possible in the case of a combined rolling bearing for the bearing outer ring to be the same component or a unitary component equally for the axial bearing and for the radial bearing.

A rolling bearing device within the meaning of this disclosure is a device which is configured to rotatably mount a shaft component with respect to a housing component, with rolling bodies, which move in so-called bearing rings, being provided to allow the rotational movement between the shaft component to be mounted and the housing component. A plurality of identical or different rolling bearing devices can be provided to mount the shaft component. The prior art discloses simple rolling bearing devices of different designs, in particular so-called roller bearings, ball bearings and the like, with the prior art also disclosing, as explained above, combining a plurality of these simple rolling bearing devices to form a rolling bearing device. The proposed rolling bearing device has a radial bearing for absorbing radial forces. Furthermore, this radial bearing has a multiplicity of rolling bodies, and preferably this multiplicity of rolling bodies is guided, for example held in position, by way of a so-called cage. In addition to the radial bearing, the proposed rolling bearing device has an axial bearing with a second multiplicity of rolling bodies, and preferably this second multiplicity of rolling bodies is guided, for example held in position, by way of a further cage.

The rolling bearing device is configured for rotatably mounting a shaft component with respect to a housing component about a bearing axis; the bearing axis here can also be understood to mean a longitudinal axis or an axis of symmetry. The first and the second multiplicity of rolling bodies are each arranged between two bearing rings such that the latter are oriented concentrically to one another and to the bearing axis. The first and second multiplicity of rolling bodies each contact a common bearing outer ring, with the latter having an outer circumferential surface. This outer circumferential surface is configured to be inserted into or to contact a housing component. Furthermore, the first multiplicity of rolling bodies contacts a radial bearing inner ring; in other words, the common bearing outer ring, the first multiplicity of rolling bodies and the radial bearing inner ring form the main components of the radial bearing of the rolling bearing device. As explained, the rolling bearing device has the second multiplicity of rolling bodies which contact an axial bearing inner ring, with the axial bearing inner ring being a separate component, as is the radial bearing inner ring; in other words, the common bearing outer ring, the second multiplicity of rolling bodies and the axial bearing inner ring form the main components of the axial bearing of the rolling bearing device. By virtue of the explained arrangement of the components, the common outer bearing ring, the axial bearing inner ring and the radial bearing inner ring are oriented concentrically to the bearing axis and allow the precise mounting of a shaft component, which contacts at least one of these inner rings, with respect to a housing component, which contacts the common bearing outer ring.

In the proposed rolling bearing device, the radial bearing inner ring has a radial bearing inner circumferential surface which is configured to contact a shaft component such that the radial bearing inner ring is received thereon, and furthermore, the axial bearing inner ring has an axial bearing inner circumferential surface. Preferably, these inner circumferential surfaces (radial bearing inner circumferential surface, axial bearing inner circumferential surface) are at least substantially circular cylindrical lateral surfaces which are arranged concentrically to one another and to the bearing axis. It is proposed that the axial bearing inner circumferential surface has a larger inside diameter than the radial bearing inner circumferential surface. In graphic terms, the radial bearing inner ring has, as inside diameter, a bearing nominal diameter, and the axial bearing inner ring has a diameter which is increased, at least slightly, with respect to this bearing nominal diameter, with the result that the axial bearing inner ring is free in the radial direction.

It is further proposed that the common bearing outer ring completely covers the first and the second multiplicity of rolling bodies in a longitudinal direction of the bearing axis. In particular, such a configuration makes it possible for the rolling bearing device to have a compact design, and furthermore, it is able to be mounted in a simple manner. Furthermore, the common bearing outer ring is configured in such a way as to have an axial bearing raceway which is configured as an indentation in the radial direction, that is to say orthogonally to the bearing axis, in the common bearing outer ring, and thus allows force to be transmitted, in both directions of the bearing axis, to the second multiplicity of rolling bodies. In particular, such a configuration makes it possible to obtain a rolling bearing device by way of which axial forces are made possible in both directions of the bearing axis.

In a preferred embodiment of the disclosure, the rolling bearing device has a holding recess. This holding recess is configured as an indentation, preferably as a radially encircling indentation; in graphic terms, it is thus configured as a so-called groove in the common bearing outer ring. This holding recess is arranged in particular in or on the outer circumferential surface of the common bearing outer ring. In particular, the insertion of an elastic securing ring into the holding recess makes it possible for the common bearing outer ring to be connected in a form fitting manner to a housing into which the rolling bearing device is inserted in its planned installation situation, thereby allowing the common bearing outer ring to be fastened in a space-saving manner.

In a preferred embodiment of the disclosure, the rolling bodies of the second multiplicity of rolling bodies take the form of spherical rolling bodies or balls, and further preferably, the axial bearing of the rolling bearing device takes the form of a so-called four-point bearing. What is to be understood by a four-point bearing within this meaning is a single-row radial angular-contact ball bearing whose raceways, on which the second multiplicity of rolling bodies run in the common bearing outer ring or in the axial bearing inner ring during a rotation of the axial bearing inner ring with respect to the common bearing outer ring, are designed in such a way that axial loads, that is to say loads in both directions of the bearing axis, can be absorbed by this axial bearing. In particular, this embodiment of the disclosure makes it possible, when mounting a shaft with respect to a housing, to use, in addition to this rolling bearing device, only one radial bearing which does not absorb axial forces; this leads to an efficient mounting and it is thus possible to increase the efficiency of a drive arrangement in which the proposed rolling bearing device is used for mounting a shaft.

In a preferred embodiment of the rolling bearing device, in particular with a four-point bearing as axial bearing, the axial bearing inner ring takes the form of a one-piece bearing ring. In particular, a one-piece axial bearing inner ring makes it possible to realize a low-play axial bearing.

In a preferred embodiment of the rolling bearing device, at least one of the two inner rings, that is to say either the axial bearing inner ring or the radial bearing inner ring or both, has an inner ring holding recess. Furthermore, it is proposed that this inner ring holding recess, like the holding recess in the common bearing outer ring, takes the form of a radially encircling recess. The inner ring holding recess is formed in the respective inner circumferential surface, in particular is formed therein as a radially encircling indentation, the inner ring holding recess is arranged.

Also proposed is a drive arrangement which is configured in particular to provide drive power to overcome traveling resistance in a motor vehicle, preferably a passenger car. Further preferably, this drive arrangement has at least one shaft component which is rotatably mounted with respect to a housing component. To implement the rotatable mounting of this shaft component with respect to the housing component, the drive arrangement has a rolling bearing device of the proposed type such that the shaft component is rotatable about the bearing axis, and further preferably, for rotatable mounting, the drive arrangement also has at least one further bearing, preferably a further rolling bearing and particularly preferably a further radial bearing. Such a drive arrangement makes it possible to achieve a high degree of efficiency, in particular owing to the efficient rotatable mounting of the shaft component.

### BRIEF DESCRIPTION OF THE DRAWINGS

Individual features and a preferred embodiment of the disclosure are explained in more detail below on the basis of the drawings.

FIG. 1 shows a schematic sectional illustration, in half-section, of a rolling bearing device with a radial bearing and an axial bearing.

FIG. 2 shows a schematic sectional illustration, in half-section, of a rolling bearing device with a radial bearing and an axial bearing, in the installed state.

### DETAILED DESCRIPTION OF THE DRAWINGS

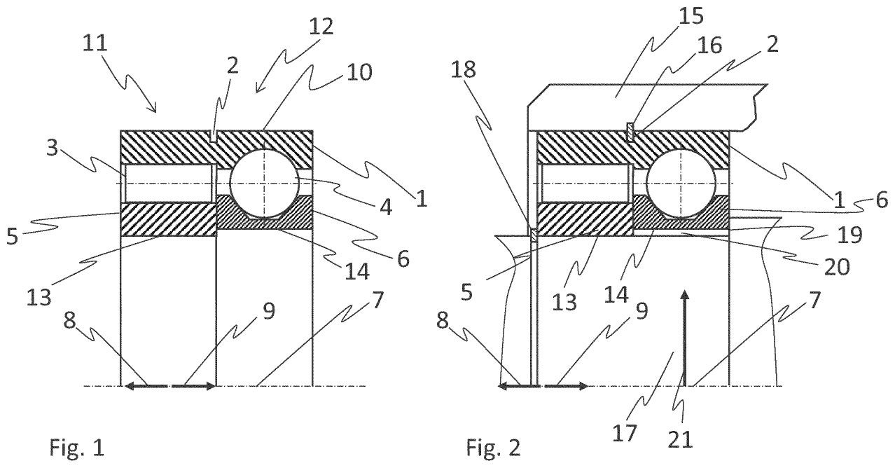

FIG. 1 illustrates a half-section of a rolling bearing device, with the rolling bearing device having a radial bearing 11 and an axial bearing 12, or combining them to form a unit. The common bearing outer ring 1 has a holding recess, which is configured as a groove 2 and which is arranged in the outer circumferential surface 10 of the common bearing outer ring 1. The first multiplicity of rolling bodies, of which one cylindrical roller 3 can be seen, and the second multiplicity of rolling bodies, of which one ball 4 can be seen, run in the common bearing outer ring 1. The cylindrical rollers of the first multiplicity of rolling bodies are supported on the radial bearing inner ring 5, and the balls of the second multiplicity of rolling bodies are supported on the axial bearing inner ring 6. This design of the rolling bearing device allows a shaft component to be received therein such that it can rotate about the bearing axis 7.

It can be seen that the axial bearing inner ring 6 receives the ball 4, and thus the second multiplicity of rolling bodies, in such a way that forces can be transmitted in both directions 8, 9 of the bearing axis 7 by way of the axial bearing of the rolling bearing device. The radial bearing inner ring 5 has the cylindrical radial bearing inner circumferential surface 13, and the axial bearing inner ring 6 has the cylindrical axial bearing inner circumferential surface 14. It can be seen in the sectional illustration that the diameter of the radial bearing inner circumferential surface 13 is smaller (this corresponds to the so-called bearing nominal diameter) than the diameter of the radial bearing inner circumferential surface 14. Owing to the geometry of the rolling bearing device that results from this jump in diameter, the axial bearing inside diameter is radially free. Furthermore, the common outer bearing ring 12 is configured in such a way that it completely covers both the first and the second multiplicity of rolling bodies in the longitudinal direction, that is to say in the direction of the bearing axis 7, and in particular this configuration, in conjunction with the already explained configuration of the axial bearing inner ring 6, allows forces to be transmitted in both directions 8, 9 by the axial bearing 12 of the rolling bearing device.

FIG. 2 is a half-section illustration showing a rolling bearing device of the above-explained design in its planned installation situation, and therefore the features resulting from the installation situation of the rolling bearing device will be discussed in the main below. An elastic securing ring 16 is inserted into the groove 2, which securing ring engages, in the housing component 15, in a groove forming a mirror-image counterpart to the groove 2, and thus fastens the common bearing outer ring 1 in the housing component 15 in a form-fitting manner. On the shaft component 17 there is provided a likewise elastic further securing ring 18 which, in conjunction with a shaft shoulder 19 of the shaft component 17 and a shaft groove, into which this ring is inserted, fastens both the radial bearing inner ring 5 and the axial bearing inner ring 6 on the shaft component 17. The fact that the axial bearing inner circumferential surface 14 has a larger diameter than the radial bearing inner circumferential surface 13 results in a radial clearance 20 in the radial direction 21, that is to say orthogonally to the bearing axis 7.

Expressed in other words, a rolling bearing device is proposed which a common bearing outer ring 1 which is formed in one piece and which has a cylindrical raceway and a second raceway for the second plurality of rolling bodies, and in particular this raceway corresponds to a four-point bearing. The common bearing outer ring can have a geometry, in particular a groove, for axially securing the rolling bearing device in a housing component.

The first multiplicity of rolling bodies in particular takes the form of a set of cylindrical rollers, and the latter are preferably guided by a first bearing cage. Furthermore, the rolling bearing device has a second multiplicity of rolling bodies, which preferably take the form of a set of rolling bearing balls, and the latter are preferably guided by a second bearing cage. The radial bearing of the rolling bearing device has a radial bearing inner ring with a, preferably cylindrical, raceway on which the first multiplicity of rolling bodies run during the planned operation (shaft component rotates with respect to housing component) of the rolling bearing device. Furthermore, this radial bearing inner ring has a radial bearing inner circumferential surface, which preferably has the bearing inside nominal diameter. In addition to the radial bearing inner ring, the rolling bearing device additionally has a further bearing inner ring, the so-called axial bearing inner ring, which forms the inner raceway for the second multiplicity of rolling bodies and thus preferably forms a four-point bearing, in conjunction with the common bearing outer ring, of the second multiplicity of rolling bodies. It is proposed here that this axial bearing inner ring has a diameter which is increased with respect to the bearing inside nominal diameter, that is to say with respect to the diameter of the radial bearing inner circumferential surface, such that the rolling bearing device, insofar as it has been fitted onto a bearing seat on a shaft component with a constant diameter over the length of the bearing seat, has a clearance in the radial direction at the axial bearing inner ring. Furthermore, it is proposed (not shown) that one of the two bearing inner rings (radial bearing inner ring, axial bearing inner ring) has a geometry for axial securement, and such a geometry can be configured as a groove.

One concept of the proposed rolling bearing device is that the second axial bearing inner ring is radially free, that is to say the inside diameter of this inner ring is larger than the inside diameter of the radial bearing inner ring, which preferably has the nominal diameter of the rolling bearing device. In particular, this configuration of the rolling bearing device makes it possible to achieve a situation in which the four-point bearing bears only axial loads and not radial loads.

Preferably, the raceways for the second multiplicity of rolling bodies, that is to say preferably the balls, are geometrically configured in such a way that these rolling bodies each bear/run on four points/tracks and can thus form a so-called four-point bearing. Furthermore, the axial bearing inner ring can be formed in one piece.

### LIST OF REFERENCE SIGNS

1 Common bearing outer ring
2 Groove
3 Cylindrical roller (rolling body of the first multiplicity of rolling bodies)
4 Ball (rolling body of the second multiplicity of rolling bodies)
5 Radial bearing inner ring
6 Axial bearing inner ring
7 Bearing axis
8, 9 Directions parallel to 7
10 Outer circumferential surface
11 Radial bearing
12 Axial bearing
13 Radial bearing inner circumferential surface
14 Axial bearing inner circumferential surface
15 Housing component
16 Securing ring
17 Shaft component
18 Further securing ring
19 Shaft shoulder
20 Radial clearance
21 Radial direction

1.-6. (canceled)

7. A rolling bearing device comprising:
a radial bearing with a first multiplicity of rolling bodies and an axial bearing with a second multiplicity of rolling bodies, wherein the rolling bearing device is configured for rotatably mounting a shaft component with respect to a housing component about a bearing axis, and wherein:
the first and the second multiplicity of rolling bodies contact a common bearing outer ring which has an outer circumferential surface,
the first multiplicity of rolling bodies contact a radial bearing inner ring, and the second multiplicity of rolling bodies contact an axial bearing inner ring,
the common bearing outer ring, the axial bearing inner ring and the radial bearing inner ring are oriented concentrically to the bearing axis,
the radial bearing inner ring is configured, at a radial bearing inner circumferential surface, to contact a shaft component,
the axial bearing inner ring has an axial bearing inner circumferential surface which is arranged concentrically to the radial bearing inner circumferential surface and to the bearing axis,
the axial bearing inner circumferential surface has a larger inside diameter than the radial bearing inner circumferential surface, and
the common bearing outer ring completely covers the first and the second multiplicity of rolling bodies in a longitudinal direction of the bearing axis.

8. The rolling bearing device according to claim 7, wherein the common bearing outer ring has a holding recess in the outer circumferential surface, and the holding recess is a radially encircling recess.

9. The rolling bearing device according to claim 7, wherein the axial bearing is a four-point bearing.

10. The rolling bearing device according to claim 9, wherein the axial bearing inner ring is a one-piece bearing ring.

11. The rolling bearing device according to claim 7, wherein at least one of the two inner rings has an inner ring holding recess, and the inner ring holding recess is arranged as a radially encircling recess in the respective inner circumferential surface.

12. A drive device having a roller-bearing-mounted shaft component with a rolling bearing device according to claim 7, wherein the shaft component is rotatably mounted with respect to a housing component about the bearing axis by way of the rolling bearing device.
